(19) United States
(12) Patent Application Publication
(10) Pub. No.: US 2011/0001794 A1
(43) Pub. Date: Jan. 6, 2011

(54) SYSTEM AND METHOD FOR SHAPE CAPTURING AS USED IN PROSTHETICS, ORTHOTICS AND PEDORTHICS

(76) Inventor: Amit V. Bhanti, Peoria, IL (US)

Correspondence Address: Marcellus A. Chase, Patent Attorney, 1010 Grand Boulevard, Suite 500, Kansas City, MO, 64106, US

(21) Appl. No.: 12/717,113

(22) Filed: Mar. 3, 2010

Related U.S. Application Data
(60) Provisional application No. 61/157,066, filed on Mar. 3, 2009.

(51) Int. Cl. H04N 13/02

(52) U.S. Cl. 348/46; 348/E13.074

(57) ABSTRACT

Systems and methods are provided to capture a digital 3D image of a portion of a subject's body. The systems and methods may be effective under static or dynamic conditions, either under the weight of a load or under non-weighted conditions. The system includes a grid of intersecting, flexible fibers arranged so as to achieve a variable surface contour. The surface contour of the grid conforms to and matches the surface contour of the subject when the grid covers a portion of the subject (i.e. residual limb, or deformity to correct). The coordinates of each point of intersection of two or more flexible fibers of the grid is recorded and produces a signal that generates a digital 3D image corresponding to the surface contour of the subject. The method includes covering a portion of the subject (i.e. residual limb or deformity to correct) with a grid of intersecting, flexible fibers and generating a digital three dimensional image. Optionally, the method may further include using the digital 3D image to create a prosthesis, orthosis, or foot orthosis having a surface contour matching the surface contour of the subject.

### CROSS-REFERENCE

This application claims the benefit of, and priority based upon, co-pending U.S. Provisional Patent Application Ser. No. 61/157,066, entitled “System and Method for Shape Capturing as used in Prosthetics, Orthotics and Pedorthics”, filed Mar. 3, 2009, the entire disclosure of which is herein incorporated by reference.

### FIELD

The present application relates generally to systems, and related methods, to capture an image or shape of a residual limb or body shape of a subject under static or dynamic load conditions, in prosthetic, orthotic, and pedorthic applications.

### BACKGROUND

Prosthetics, orthotics, and pedorthics are allied health fields that provide a vital service to people with physical disabilities and/or deformities. Prosthetics relates to the replacement of missing body parts with artificial structures. Orthotics relates to devices that support or correct musculoskeletal deformities and/or abnormalities of the human body. Pedorthics relates to foot devices as prescribed for relief of painful or disabling conditions of the foot or lower limb. An important aspect of any treatment is to provide one or more device that attaches to a subject's body (e.g., prostheses, orthoses, and/or pedorthoses). Treatment is intended to enable recipients to return to their families, place of work, and to more fully participate in society.

In the prosthetic, orthotic and pedorthic fields of medicine, precise, customized clinical support devices, such as prosthetic limbs, orthotic braces, or pedorthic devices, need to be constructed from custom shapes that are unique to each subject. A mold is used to generate a custom shape. Sometimes, these custom shapes need to be reproduced, with minor variations, over time. These minor variations may be applied to the mold or directly to the custom shape. Capturing the shape of a three dimensional object (including, but not limited to, a body part to be supported and/or a body part on which a device is to be supported) is quite important. The quality, accuracy and precision of the shape-capturing techniques and devices will directly correlate to the effectiveness of the treatment and general overall satisfaction of the subject.

Although prosthetics, orthotics, and pedorthics are different fields of medicine, techniques and devices used to image-capture the shape of a subject's body are generally applicable to all three. In the case of a prosthetic limb, a support socket is generally adapted to be fitted over the terminal portion of a subject's limb to act as a replacement for the missing limb. The support socket is a custom shape that is unique to each subject. A precise fit is required because of the pressure exerted on the terminal end of the limb during use. The support socket should fit in such a manner that any pressure exerted on the terminal end of the limb is evenly distributed; thereby preventing any concentrated or focused pressure on any localized portion of the terminal end of the limb. In the case of an orthosis, a brace is generated to correct a deformity or abnormality or support a weakened body part. As with prosthetics, a custom shape of a portion of the subject's body is determined. Once the precise custom shape is determined, it is modified, somewhat, to compensate for the deformity or abnormality. Over time, additional orthoses may be required with varying modifications from the original subject's body shape. In the case of a pedorthosis, a device is created to ease a painful or disabling foot condition. As with prosthetics and orthotics, a custom shape of a subject's foot or lower limb is determined. The precise custom shape is then used (or modified) to create the device.

Numerous methods are known for developing the proximal section of a prosthetic socket. One of the prominent methods being widely used is the casting method which uses plaster of Paris bandages or resin-based casting tapes. Some of the disadvantages associated with this casting method are that it is time consuming, inconsistent, expensive, messy, needs huge storage space, reproduction secondary adjustment is difficult, needs expensive CAD tools for conversion to a CAD model, and storage of mold is difficult. This casting method requires highly skilled medical personnel to manually manipulate the subject's limb in a non-weight-bearing condition and simultaneously account for any observed anatomical deformities in the limb. If the subject is situated in a remote location, portability of the mold becomes a major disadvantage.

Other prominent technologies being used for image capture include optical/digital scanner/tracer systems, such as OMEGA TRACER, BIOSCULPTOR, and HANGER INSIGNIA. These optical/digital scanner/tracer systems require a scanner to capture coordinates of the limb. However, these are very expensive techniques and require very expensive hardware. These are cost-prohibitive for most clinics. Additionally, these systems require steep learning curves to understand the process and techniques, thus making them even more expensive. These systems have limited application and require bulky machinery, equipment, and training Furthermore, the effectiveness may be impaired by various factors. Various lighting conditions or environmental conditions such as the presence of certain metals may cause interference. These optical/digital scanner/tracer systems are unable to take readings under dynamic or weight-bearing conditions. The biggest disadvantage of these, however, is that they can not scan in corrected positions in case of deformity or a contracture.

Thus there is a long-felt, unmet need to provide an alternative for prosthetic, orthotic, and pedorthic practitioners, and their subjects, at a lower cost than the current state-of-the-art, while continuing to utilize computer software in designing components to fabricate custom sockets or braces.

### SUMMARY

The present inventive concept provides a system and method to capture the shape of a body part, in a digital format, such that prostheses, orthoses, and/or foot orthoses may be created. By employing the systems and methods taught, herein, a device is produced that fits better, is able to be created in a more timely manner, and is more cost-effective than the current state-of-the art. This reduces the overall labor, time, cost, and repeated modifications needed using conventional means as they are applied in current practice. By using the system and methods taught, herein, a practitioner need not buy expensive proprietary software and/or go through expensive and time-consuming training The practitioner instead uses previously-learned skills and techniques to obtain the high-quality, accurate, and precise scans in a digital format. Moreover, this system is at least as portable as the traditional plaster of Paris bandage, prior to usage, but without the cumbersome post-image-capture storage problems (i.e. storage of the mold).

An object of the instant inventive concept is to provide a system to capture the shape and dimensions of a subject's extremity accurately and with precision. This system allows a prosthetist, orthotist, pedorthist and/or assistant to capture a digital 3D image of a residual limb and/or body part under static or dynamic conditions, either under the weight of a load or not and with the ability to apply corrective forces during the scanning process to obtain the maximally corrected position. The system includes a grid of intersecting, flexible fibers arranged so as to achieve a variable surface contour. The surface contour of the grid conforms to and matches the surface contour of the subject when the grid covers a portion of the subject (i.e. residual limb, or deformity to correct). The coordinates of each point of intersection of two or more flexible fibers of the grid is recorded and produces a signal that generates a digital 3D image corresponding to the surface contour of the subject.

Another object of the instant inventive concept is to provide a method for capturing a digital 3D image of a portion of a subject's body. The method includes covering a portion of the subject (i.e. residual limb or deformity to correct) with a grid of intersecting, flexible fibers and generating a digital three dimensional image. The fibers are arranged so as to achieve a variable surface contour. The surface contour of the grid conforms to and matches a surface contour of the subject when the grid covers a portion of the subject. The digital 3D image corresponds to the surface contour of the subject based on coordinates of each point of intersection of two or more flexible fibers of the grid. Optionally, the method may further include using the digital 3D image to create a prosthesis, orthosis, or foot orthosis having a surface contour matching/mirroring or otherwise based upon the surface contour of the subject.

The foregoing and other objects are intended to be illustrative and are not meant in a limiting sense. Many possible embodiments may be made and will be readily evident upon a study of the following specification and accompanying drawings comprising a part thereof. Various features and subcombinations may be employed without reference to other features and subcombinations. Other objects and advantages will become apparent from the following description taken in connection with the accompanying drawings, wherein is set forth by way of illustration and example, an embodiment and various features thereof.

### BRIEF DESCRIPTION OF THE DRAWINGS

One or more embodiments are set forth in the following description and is shown in the drawings and is particularly and distinctly pointed out and set forth in the appended claims.

FIG. 1 is a cross-sectional view of a grid of intersecting fibers of an embodiment of the instant invention shown with respect to a subject's leg.

FIG. 2 is a perspective view of a grid of intersecting fibers as it conforms to and matches the surface contour of a subject's foot (subject's leg and remainder of subject's body above the foot is not shown for ease of illustration of the inventive concept), and is connected to a computer to generate a 3D image of the surface contour of the subject's foot on the computer.

FIG. 3 is a perspective view of a grid of intersecting fibers as it conforms to and matches the surface contour of the terminal portion of a subject's leg, and generates a 3D image to a computer via wireless transmission.

### DETAILED DESCRIPTION

As required, a detailed embodiment of the present inventive concept is disclosed herein; however, it is to be understood that the disclosed embodiment is merely exemplary of the principles of the inventive concept, which may be embodied in various forms. Therefore, specific structural and functional details disclosed herein are not to be interpreted as limiting, but merely as a basis for the claims and as a representative basis for teaching one skilled in the art to variously employ the present inventive concept in virtually any appropriately detailed structure.

A system is provided to capture the shape and dimensions of a subject's extremity accurately and with precision. This system allows a prosthetist, orthotist, pedorthic and/or assistant to capture a digital 3D image of a residual limb and/or body part under static or dynamic conditions, either under the weight of a load or not. The system includes a grid of intersecting, flexible fibers arranged so as to achieve a variable surface contour. The surface contour of the grid conforms to and matches the surface contour of the subject when the grid covers a portion of the subject (i.e. residual limb, or deformity to correct). The coordinates of each point of intersection of two or more flexible fibers of the grid is recorded and produces a signal that generates a digital 3D image corresponding to the surface contour of the subject.

The system provides for capturing shapes of different body parts using a grid of intersecting, flexible fibers arranged in the shape of a sock, glove, liner, or other shape convenient for prosthetic, orthotic, and/or pedorthic applications. This system digitizes the coordinates of the intersecting points of grid fibers to capture the surface contour of the portion of the subject's body. Once the system has captured the 3D image of the subject, the image is used to generate the appropriate treatment device, brace, and/or device. It is envisioned that the manufacture of the treatment device, brace, and/or device may be accomplished at a location remote from the subject. In some embodiments, the fibers have an elastic quality such that they stretch and can conform to the shape of the body part. Sensors detect the amount of elastic strain and/or distance of “stretch” on each fiber.

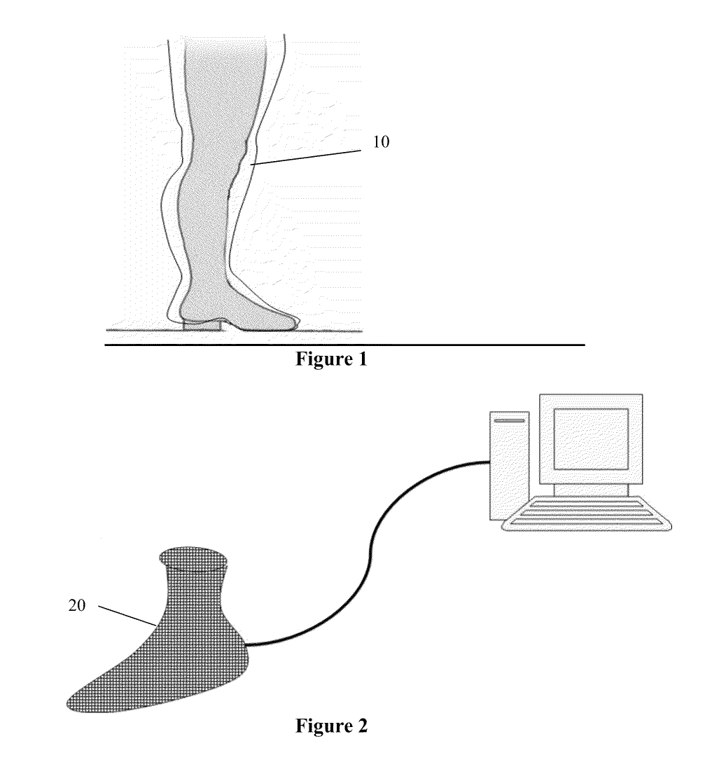

Referring to FIG. 1, a cross-sectional view of a grid (10) of intersecting fibers is provided. The grid (10) is shown with respect to a subject's leg. The grid conforms to and matches the surface contour of the subject's leg. Coordinates are assigned to each location where two or more fibers intersect. Based on these sets of coordinates, a digital 3D image of the subject's leg is generated on a computer.

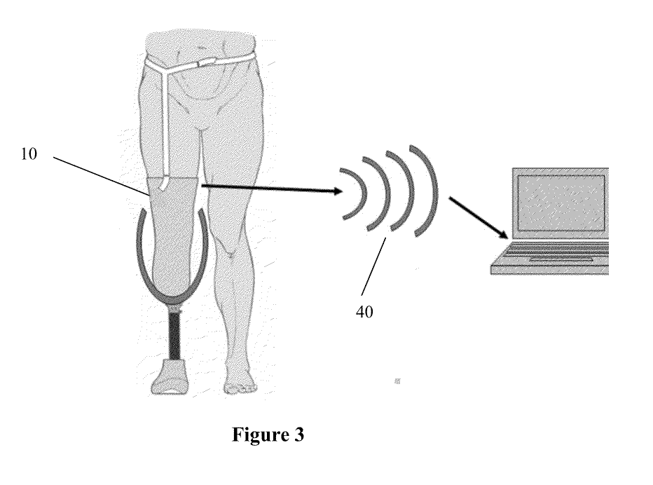

Referring to FIG. 2, a perspective view of a grid (20) of intersecting fibers and its connection to a computer is provided. The grid (20) conforms to and matches the surface contour of a subject's foot. The grid (20) is connected to a computer to generate a 3D image of the surface contour of the subject's foot on the computer.

Referring to FIG. 3, a perspective view of a grid (10) of intersecting fibers in relation to a human leg prosthesis and wireless communication with a computer is shown. The grid (10) conforms to and matches the surface contour of the terminal portion of a subject's leg. The grid (10) generates a 3D image to a computer via wireless transmission.

This system may be used to image-capture shape under a weighted load or under non-weighted conditions. This system may be used during dynamic conditions, such as walking, or static conditions such as sitting or standing still. Obtaining weight-bearing scans of an amputated limb is not possible with current state-of-the-art technology. It is beneficial in orthotic and prosthetic applications to obtain weight-bearing scans as it is a realistic assessment of soft tissue behavior under load. It allows the medical personnel to partially mimic what the prostheses, orthoses, or pedortheses will have to support. The ability of this system to capture the shape of the anatomy with an understanding of soft tissue behavior under pressure, compressive, tensile and deforming forces will better guide medical personnel in performing appropriate modifications and creating a better fitting prostheses, orthoses, or pedortheses.

The system is a useful interface during the diagnostic socket fitting in assessing exactly how the extremity behaves when bearing weight with the prostheses, orthoses, or pedortheses connected to the subject. It will be appreciated that the system of the instant inventive concept may be used with various accessories not shown herein but that will be apparent to those of ordinary skill in the art. It will also be appreciated that the system of the instant inventive concept may also be used for all socket scans that may be improved if performed under weight-bearing conditions using temporary residual limb receptacles. When the subject walks with the system in place, the system will capture the shape of the residual limb at the most comfortable point in the gait cycle.

The system can be made in various sizes and lengths, similar to stockings with a grid of intersecting fibers weaved into it. When the system is applied on the residual limb, the grid of the fibers are displaced from their initial starting position. The points of intersection of the fibers correspond to new coordinates. These coordinates are digitized and the corresponding signal is sent to the computer which in turn generates a 3D image of the residual limb. This shape is then manipulated and modified by a trained professional on an orthotic & prosthetic CAD system to add additional features, functions, and/or corrections as required by the practitioner's prescription. This shape is then utilized to carve a mold of the residual limb or affected extremity which is ultimately used to form the prosthetic socket for use by an amputee or an orthoses to correct a deformity or support a weakened limb or relieve a painful bone or an ulcer.

Once the information on the topography of the residual limb is captured as a 3D image, it is transmitted to the manufacturing facility by any known means, such as delivery on a machine readable storage medium, by wired or wireless transmission over the internet or extranet, or by direct transfer from machine to machine. If the subject is situated at a location remote from the manufacturing facility, the image-capturing system can be transported to the location of the subject without additional costs and burdens associated with the current state-of-the-art. The image is captured electronically and transmitted to the manufacturing location. This will reduce the overall cost to provide services. It is envisioned that in many cases, the practitioner may be able to provide tele-medicine consultation in a real time manner when the subject and/or practitioner is unable to travel to reach one another.

A method is also provided for capturing a digital 3D image of a portion of a subject's body. The method includes covering a portion of the subject (i.e. residual limb or deformity to correct) with a grid of intersecting, flexible fibers and generating a digital three dimensional image. The fibers are arranged so as to achieve a variable surface contour. The surface contour of the grid conforms to and matches a surface contour of the subject when the grid covers a portion of the subject. The digital 3D image corresponds to the surface contour of the subject based on coordinates of each point of intersection of two or more flexible fibers of the grid. Optionally, the method may further include using the digital 3D image to create a prosthesis, orthosis, or foot orthosis having a surface contour matching the surface contour of the subject.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration provided herein is by way of example, and the scope of the application is not limited to the exact details shown or described.

Although the foregoing detailed description has been described by reference to a number of exemplary embodiments, it will be understood that certain changes, modification or variations may be made in embodying the above application, and in the construction thereof, other than those specifically set forth herein, may be achieved by those skilled in the art without departing from the spirit and scope of the application, and that such changes, modification or variations are to be considered as being within the overall scope of the present application. Therefore, it is contemplated to cover the present application and any and all changes, modifications, variations, or equivalents that fall within the true spirit and scope of the underlying principles disclosed and claimed herein. Consequently, the scope of the present application is intended to be limited only by the attached claims, all matter contained in the above description and shown in the accompanying drawings shall be interpreted as illustrative and not in a limiting sense.

What is claimed is:

1. A system for capturing a digital 3D image of a portion of a subject's body, the system comprising:
a grid of intersecting, flexible fibers having a variable surface contour;
wherein,
the surface contour of the grid conforms to and matches a surface contour of the subject, when the grid covers a portion of the subject; and
coordinates of each point of intersection of two or more flexible fibers of the grid is recorded and produces a signal that generates a digital 3D image corresponding to the surface contour of the subject.

2. The system of claim 1, wherein the surface contour of the grid conforms to and matches a surface contour of the subject, when the grid covers a portion of the subject under static load conditions.

3. The system of claim 1, wherein the surface contour of the grid conforms to and matches a surface contour of the subject, when the grid covers a portion of the subject under dynamic load conditions.

4. The system of claim 1, wherein the surface contour of the grid conforms to and matches a surface contour of the subject, when the grid covers a portion of the subject under weighted conditions.

5. The system of claim 1, wherein the surface contour of the grid conforms to and matches a surface contour of the subject, when the grid covers a portion of the subject under non-weighted conditions.

6. The system of claim 1, wherein the surface contour of the grid conforms to and matches a surface contour of the subject, when the grid covers a portion of the subject and a corrective force is applied to the portion of the subject.

7. The system of claim 1, wherein the signal is transmitted wirelessly.

8. The system of claim 1, wherein the 3D image is used to create a prosthesis, orthosis, or foot orthosis.

9. The system of claim 1, wherein the grid of intersecting, flexible fibers are arranged in the shape of a sock or glove.

10. The system of claim 1, wherein at least one of the flexible fibers has an elastic quality.

11. The system of claim 10, wherein at least one sensor detects an amount of elastic strain.

12. The system of claim 11, wherein the elastic strain detected is recorded and is used to produce the signal that generates the digital 3D image.

13. The system of claim 10, wherein at least one sensor detects a distance of stretch of each flexible fiber.

14. The system of claim 13, wherein the stretch detected is recorded and is used to produce the signal that generates the digital 3D image.

15. A method for capturing a digital 3D image of a portion of a subject's body, the method comprising:
covering a portion of a subject with a grid of intersecting, flexible fibers having a variable surface contour, wherein, the surface contour of the grid conforms to and matches a surface contour of the subject, when the grid covers a portion of the subject; and
generating a digital three dimensional image corresponding to the surface contour of the subject based on coordinates of each point of intersection of two or more flexible fibers of the grid.

16. The method of claim 15, further comprising:
creating a prosthesis or orthosis having a surface contour matching the surface contour of the subject.

17. The method of claim 15, wherein the method is performed under static load conditions.

18. The method of claim 15, wherein the method is performed under dynamic load conditions.

19. The method of claim 15, wherein the method is performed under weighted conditions.

20. The method of claim 15, wherein the method is performed under non-weighted conditions.

21. The method of claim 15, further comprising: applying a corrective force to the portion of the subject.
